(19) United States
(12) Patent Application Publication
(10) Pub. No.: US 2014/0045060 A1
(43) Pub. Date: Feb. 13, 2014

(54) COMPOSITE ANODE ACTIVE MATERIAL, ANODE AND LITHIUM BATTERY EACH INCLUDING THE COMPOSITE ANODE ACTIVE MATERIAL, AND METHOD OF PREPARING THE COMPOSITE ANODE ACTIVE MATERIAL

(71) Applicant: SAMSUNG SDI CO., LTD., Yongin-si (KR)

(72) Inventors: Sang-Eun Park, Yongin-si (KR); Jae-Myung Kim, Yongin-si (KR); So-Ra Lee, Yongin-si (KR); Yu-Jeong Cho, Yongin-si (KR); Ui-Song Do, Yongin-si (KR); Chang-Su Shin, Yongin-si (KR); Su-Kyung Lee, Yongin-si (KR)

(73) Assignee: Samsung SDI Co., Ltd., Yongin-si (KR)

(21) Appl. No.: 13/776,434

(22) Filed: Feb. 25, 2013

(30) Foreign Application Priority Data
Aug. 13, 2012 (KR) 10-2012-0088626

(51) Int. Cl. H01M 4/36

(52) U.S. Cl. CPC H01M 4/366
USPC 429/211; 429/231.8; 429/223; 429/224; 429/231.6; 429/231.5; 429/221; 429/220; 429/231; 252/182.1

(57) ABSTRACT

In an aspect, a composite anode active material including a composite core; and a coating layer covering at least a region of the composite core, wherein the composite core comprises a carbonaceous substrate; and a nanostructure disposed on the substrate, and the coating layer includes a metal oxide; an anode and a lithium battery each including the composite anode active material; and a method of preparing the composite anode active material are provided.

### CROSS-REFERENCE TO RELATED APPLICATION

This application claims the benefit of Korean Patent Application No. 10-2012-0088626 filed on Aug. 13, 2012 in the Korean Intellectual Property Office, the disclosure of which is incorporated in its entirety herein by reference.

### BACKGROUND

1. Field

One or more embodiments of the present disclosure relate to a composite anode active material, an anode and a lithium battery each including the composite anode active material, and a method of preparing the composite anode active material.

2. Description of the Related Technology

Lithium batteries have high voltage and high energy density, and thus are used in various applications. Devices such as electric vehicles (HEV, PHEV), and the like should be operable at high temperatures, be able to charge or discharge a large amount of electricity, and have long-term usability, and thus require lithium batteries having high-discharge capacity and better lifetime characteristics.

Carbonaceous materials are porous and stable with little volumetric change during charging and discharging. However, carbonaceous materials may lead to a low-battery capacity due to the porous structure of carbon. For example, graphite, which is an ultra-high crystalline material, has a theoretical capacity density of about 372 mAh/g when made into a structure in the form of LiC6.

In addition, metals that are alloyable with lithium may be used as an anode active material with a higher electrical capacity as compared with carbonaceous materials. Examples of metals that are alloyable with lithium are silicon (Si), tin (Sn), aluminum (Al), and the like. These metals alloyable with lithium are apt to deteriorate and have relatively poor lifetime characteristics. For example, by the repeated charging and discharging operations, repeated aggregation and breakage of Si particles may occur, and it leads to electric disconnection of the Si particles.

Therefore, there is a demand for a lithium battery with improved discharge capacity and lifetime characteristics.

### SUMMARY

Some embodiments provide a novel composite anode active material including a composite core with a metal oxide thereon, and a lithium battery including the composite anode active material.

Additional aspects will be set forth in part in the description which follows and, in part, will be apparent from the description, or may be learned by practice of the presented embodiments.

Some embodiments provide a composite anode active material including: a composite core; and a coating layer covering at least a region of the composite core, wherein the composite core includes a carbonaceous substrate; and nanostructure disposed on the substrate, and the coating layer comprises a metal oxide. In some embodiments, the nanostructure includes a metal/metalloid.

Some embodiments provide an anode including a composite anode active material as disclosed and described herein.

Some embodiments provide a lithium battery includes an anode as disclosed and described herein.

Some embodiments provide a method of preparing a composite anode active material includes: mixing a metal alkoxide, a composite, and a solvent together to prepare a mixed solution; drying the mixed solution to obtain a dried product; and heating the dried product, wherein the composite includes a carbonaceous substrate; and a nanostructure disposed on the carbonaceous substrate. In some embodiments, the nanostructure includes a metal/metalloid.

### BRIEF DESCRIPTION OF THE DRAWINGS

These and/or other aspects will become apparent and more readily appreciated from the following description of the embodiments, taken in conjunction with the accompanying drawings of which:

FIG. 1A is a scanning electron microscopic (SEM) image of a composite anode active material before thermal treatment in Example 1;

FIG. 1B is a SEM image of the composite active material after the thermal treatment in Example 1;

FIG. 2A is a SEM image of a composite anode active material before thermal treatment in Example 2;

FIG. 2B is a SEM image of the composite anode active material after the thermal treatment in Example 2;

FIG. 3A is a SEM image of a composite anode active material before thermal treatment in Example 3;

FIG. 3B is a SEM image of the composite anode active material after the thermal treatment in Example 3;

FIG. 4 is a SEM image of a composite anode active material prepared in Comparative Example 1;

FIG. 5 is a graph showing lifetime characteristics of lithium batteries of Examples 6 to 10 and Comparative Example 2; and

FIG. 6 is a schematic view of a lithium battery according to an embodiment.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, one or more embodiments of a composite anode active material, an anode and a lithium battery each including the composite anode active material, and a method of preparing the composite anode active material will be described in greater detail.

Some embodiments provide a composite anode active material includes a composite core, and a coating layer covering at least a region of the composite core, wherein the composite core includes a carbonaceous substrate and a nanostructure disposed on the carbonaceous substrate.

In some embodiments, the composite anode active material may prevent a side reaction between the composite core and an electrolyte solution, and may improve lifetime characteristics when used in a lithium battery due to the inclusion of a metal oxide on the composite core. In some embodiments, the nanostructure may be a metal/metalloid nanostructure. In some embodiments, the nanostructure may further improve discharge capacity. In some embodiments, the coating layer including the metal oxide may be a protective layer for the composite core. In some embodiments, the thickness of coating layer is from about 5 nm to about 10 nm. In some embodiments, the average thickness of coating layer is from about 1 nm to about 50 nm. In some embodiments, the average thickness of coating layer is from about 0.1 nm to about 100 nm.

In some embodiments, the coating layer including the metal oxide may be formed on both the carbonaceous substrate and/or the nanostructure. In some embodiments, the nanostructure may be a metal/metalloid nanostructure. For example, the coating layer including the metal oxide may be formed on the entire surface of the composite core.

In some embodiments, the metal in the metal oxide may be at least one selected from among the elements of Groups 2 to 13 of the periodic table of elements. In other words, the metal in the metal oxide may exclude the elements of Group 1 and Groups 14 to 16 of the periodic table of elements.

For example, the metal of the metal oxide may be at least one selected from the group consisting of zirconium (Zr), nickel (Ni), cobalt (Co), manganese (Mn), boron (B), magnesium (Mg), calcium (Ca), strontium (Sr), barium (Ba), titanium (Ti), vanadium (V), iron (Fe), copper (Cu), and aluminum (Al).

In some embodiments, the metal oxide may be represented by Formula 1 below:

MₐO_{b} Formula 1

In Formula 1 above, 1≦a≦4, 1≦b≦10, and M may be at least one element selected from the group consisting of Zn, Zr, Ni, Co, Mn, B, Mg, Ca, Sr, Ba, Ti, V, Fe, Cu, and Al.

In some embodiments, the metal oxide may include at least one selected from the group consisting of titanium oxide, aluminum oxide, chromium trioxide, zinc oxide, copper oxide, magnesium oxide, zirconium dioxide, molybdenum trioxide, vanadium pentoxide, niobium pentoxide, and tantalum pentoxide. For example, the metal oxide may be TiO₂, Al₂O₃, or ZrO₂.

In some embodiments, the metal oxide may be inert to lithium. In some embodiments, the metal oxide may not react with lithium to form a lithium metal oxide. In some embodiments, the metal oxide may serve as a conductor for mere transference of lithium ions and/or electrons and a protective layer for preventing side reactions with an electrolyte solution, not as an anode active material allowing intercalation/deintercalation of lithium. In some embodiments, the metal oxide may serve as an electric insulator and a protective layer for preventing side reactions with the electrolyte solution.

In some embodiments, an amount of the metal oxide in the composite anode active material may be from about 0.1 wt % to about 20 wt % based on a total weight of the composite anode active material. In some other embodiments, the amount of the metal oxide may be from about 0.1 wt % to about 10 wt % based on the total weight of the composite anode active material. In some embodiments, a coating effect of such a small amount of the metal oxide may be negligible when the amount of the metal oxide is too low. When the amount of the metal oxide is too high, this may lead to reduced specific capacity.

In some embodiments, the inclusion of the metal/metalloid nanostructure in the composite anode active material may make it easier to accommodate a volumetric change of the metal/metalloid during charging/discharging, preventing degradation of a lithium battery. As a result, the lithium battery may have improved discharge capacity and lifetime characteristics. In some embodiments, the nanostructure may be a metal/metalloid nanostructure.

In some embodiments, the nanostructure in the composite anode active material may be formed as at least one selected from the group consisting of nanowires, nanotubes, nanobelts, nanorods, nanoporous body, and nanotemplates, but is not limited thereto. In some embodiments, the nanostructure may have any of a variety of structures on a nanoscale excluding nanoparticles.

In some embodiments, the nanostructure may be a nanowire.

As used herein, the term “nanowire” refers to a wire structure having a cross-sectional diameter on a nanometer scale. For example, the nanowire may have a cross-sectional diameter of from about 1 nm to about 500 nm, and a length of from about 0.1 μm to about 100 μm. In some embodiments, the nanowire may have an aspect ratio of from about 5 or greater, about 10 or greater, about 50 or greater, or about 100 or greater. The nanowire may have a substantially constant diameter or a varying diameter along the major axis. The major axis of the nanowire may be at least partially straight, curved, bent, or branched. In some embodiments, the nanowire may include a metal/metalloid nanowire. In some embodiments, the nanowire may effectively absorb a volumetric change of metal/metalloid in association with charging/discharging of the lithium battery.

In some embodiments, the metal/metalloid nanostructure of the composite anode active material may include at least one element selected from the group consisting of the elements of Groups 13, 14, and 15 of the periodic table of elements.

As used herein, the term “metal/metalloid” refers to an element capable of intercalating and deintercalating lithium, and that may be classified as a metal and/or a metalloid in the periodic table of elements, wherein carbon is excluded. In some embodiments, the metal/metalloid nanostructure may include an element selected from the group consisting of aluminum (Al), gallium (Ga), indium (In), thallium (Tl), silicon (Si), germanium (Ge), tin (Sn), lead (Pb), antimony (Sb), bismuth (Bi), and a combination thereof

In some embodiments, the nanostructure may be a metal/metalloid nanostructure including at least one element selected from the group consisting of Si, Ge, and Sn.

In some embodiments, the nanostructure may be a silicon-based nanowire.

As used herein, the term “silicon-based” refers to the inclusion of about 50 wt % or greater of silicon (Si), for example, at least about 60 wt %, about 70 wt %, about 80 wt %, about 90 wt %, or about 100 wt % of Si. In some embodiments, the silicon-based nanowire may be any of a variety of silicon-based materials, for example, a material selected from among Si, SiOₓ (0<x≦2), a Si-Z alloy (wherein Z is an alkali metal, an alkali earth metal, a Group 13 element, a Group 14 element, a transition metal, a rare-earth metal, or a combination thereof; and is not Si), and a combination thereof. In some embodiments, the element Z may be at least one selected from the group consisting of Mg, Ca, Sr, Ba, Ra, Sc, Y, La, Ti, Zr, Hf, V, Nb, Ta, Cr, Mo, W, Tc, Re, Fe, Ru, Os, Co, Rh, Ir, Ni, Pd, Pt, Cu, Ag, Au, Zn, Cd, B, Ge, P, As, Sb, Bi, S, Se, Te, and Po. In some embodiments, the silicon-based material, such as Si, SiOₓ, or a Si-Z alloy, may be an amorphous silicon, a crystalline silicon (either monocrystalline or polycrystalline), or a combination thereof. These silicon-based nanowires may be used alone or in a combination of at least two thereof. For example, the silicon-based nanowire may be a Si nanowire in terms of high capacity. In some embodiments, the Si nanowire may further include a dopant in order to improve conductivity. For example, the dopant may be a Group 13 element or a Group 15 element. For example, the dopant may be P (phosphorus), B (boron), or the like.

In some embodiments, the nanostructure of the composite core may be a Si nanowire. In some embodiments, the Si nanowire of the composite core may be prepared by directly growing Si nanowires on a carbonaceous substrate or by disposing previously grown Si nanowires to a carbonaceous substrate by attaching or binding the same to the carbonaceous substrate. The method of disposing the Si nanowire onto the carbonaceous substrate is not particularly limited, and may be any of widely known methods. For example, the Si nanowire may be grown using a vapor-liquid-solid (VLS) growing method, or by using a nano-sized catalyst for thermally decomposing a precursor gas near the catalyst. In some embodiments, a metal catalyst may be present or not when the Si-nanowire is directly grown on a carbonaceous substrate. Examples of the metal catalyst are Pt, Fe, Ni, Co, Au, Ag, Cu, Zn, and Cd. In some embodiments, the nanostructure may be a metal/metalloid nanostructure.

In some embodiments, an amount of the carbonaceous substrate in the composite core may be from about 60 wt % to about 99 wt %. In some embodiments, an amount of the silicon-based nanowire may be from about 1 wt % to about 40 wt %.

In some embodiments, the carbonaceous substrate of the composite core may have a spherical shape or a planar shape. When the carbonaceous substrate is circular, it may have a circularity of from about 0.7 to about 1.0. Circularity is a measure of a degree of deviation from a right circle, which may range from about 0 to 1. The nearer the number 1, the closer to the ideal circle. In some embodiments, the carbonaceous substrate may have a circularity of from about 0.8 to about 1.0, and in some other embodiments, may have a circularity of from about 0.9 to about 1.0. In some embodiments, a planar carbonaceous substrate may have a circularity of about less than 0.7.

In some embodiments, the carbonaceous substrate may include at least one selected from the group consisting of natural graphite, artificial graphite, expanded graphite, graphene, carbon black, and fullerene soot, but is not limited thereto, and may be any carbonaceous substrate known in the art. Examples of natural graphite, which is naturally occurring graphite, are flak graphite, high-crystalline graphite, and amorphous graphite. Examples of artificial graphite, which is artificially synthesized by heating amorphous carbon at a high temperature, are primary graphite, electrographite, secondary graphite, and graphite fiber. Expanded graphite is a graphite with vertically expanded molecular layer obtained by intercalating a chemical such as acid or alkali between the molecular layers of the graphite and heating the same. Graphene is a single-layered graphene. The carbon black is a crystalline material less ordered as compared with graphite. The carbon black may change into graphite when heated at about 3,000° C. for a long time. The fullerene soot is a carbon mixture including at least 3 wt % of fullerene as a polyhedral bundle compound having 60 or more carbon atoms. In some embodiments, the carbonaceous base may include one of these crystalline carbonaceous materials alone or at least two thereof. For example, the natural graphite may be used in order to obtain a anode active material composition with a higher anode mixture density in preparing an anode.

An average particle diameter of the carbonaceous substrate is not particularly limited. When the average particle diameter of the carbonaceous substrate is too small, reactivity with the electrolyte solution is so high to lower cycling characteristics. When the average particle size is too large, an anode slurry may have lower dispersion stability, so that the anode may have a rough surface. In some embodiments, the carbonaceous substrate may have an average particle diameter of from about 1 μm to about 30 μm. In some embodiments, the carbonaceous substrate may have an average particle diameter of from about 5 μm to about 25 μm, and in some other embodiments, may be from about 10 μm to about 20 μm.

In some embodiments, the carbonaceous substrate may serve as a support for the nanostructure disposed thereon, and may suppress a volumetric change of the nanostructure during charging/discharging. In some embodiments, the carbonaceous substrate may include pores. In some embodiments, the pores in the carbonaceous substrate may further effectively suppress a volumetric change of the metal/metalloid nanostructure during charging/discharging. In some embodiments, the nanostructure may be a metal/metalloid nanostructure.

Some embodiments provide an anode including a composite anode active material as disclosed and described herein. In some embodiments, the anode may be manufactured by molding an anode active material composition including the composite anode active material and a binder into a desired shape, by coating the anode active material composition on a current collector such as a copper foil, or the like.

In some embodiments, the composite anode active material, a conducting agent, a binder, and a solvent are mixed to prepare the anode active material composition. In some embodiments, the anode active material composition may be directly coated on a metallic current collector to prepare an anode plate. In some embodiments, the anode active material composition may be cast on a separate support to form an anode active material film, which may then be separated from the support and laminated on a metallic current collector to prepare an anode plate. The anode is not limited to the examples described above, and may be one of a variety of types.

In some embodiments, the anode active material composition may further include another carbonaceous anode active material, in addition to the composite anode active material. For example, the carbonaceous anode active material may at least one selected from the group consisting of natural graphite, artificial graphite, expanded graphite, graphene, carbon black, fullerene soot, carbon nanotubes, and carbon fiber, but is not limited thereto, and may be any carbonaceous substrate available in the art.

Non-limiting examples of the conducting agent are acetylene black, ketjen black, natural graphite, artificial graphite, carbon black, carbon fiber, and metal powder and metal fiber of, for example, copper, nickel, aluminum or silver. In some embodiments at least one conducting material such as polyphenylene derivatives may be used in combination. Any conducting agent available in the art may be used. The above-described crystalline carbonaceous materials may be added as the conducting agent.

In some embodiments, the binder may be a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer, but are not limited thereto. Any material available as a binding agent in the art may be used.

In some embodiments, the solvent may be N-methyl-pyrrolidone, acetone, or water, but is not limited thereto. Any material available as a solvent in the art may be used.

The amounts of the composite anode active material, the conducting agent, the binder, and the solvent are those levels that are generally used in manufacturing a lithium battery. At least one of the conducting agent, the binder and the solvent may not be used according to the use and the structure of the lithium battery.

Some embodiments provide a lithium battery including an anode including an anode active material as disclosed and described herein. In some embodiments, the lithium battery may be manufactured in the following manner.

First, an anode may be prepared according to the above-described anode manufacturing method.

Next, a cathode active material, a conducting agent, a binder, and a solvent may be mixed to prepare a cathode active material composition. The cathode active material composition may be directly coated on a metallic current collector and dried to prepare a cathode plate. In some embodiments, the cathode active material composition may be cast on a separate support to form a cathode active material film, which may then be separated from the support and laminated on a metallic current collector to prepare a cathode plate.

In some embodiments, the cathode active material may include at least one selected from the group consisting of lithium cobalt oxide, lithium nickel cobalt manganese oxide, lithium nickel cobalt aluminum oxide, lithium iron phosphorus oxide, and lithium manganese oxide. The cathode active material is not limited to these examples, and may be any cathode active material available in the art.

In some embodiments, the cathode active material may be a compound selected from the group consisting of LiₐA_{1-b}B¹_{b}D¹₂ (where 0.90≦a≦1.8, and 0≦b≦0.5); LiₐE_{1-b}B¹_{b}O_{2-c}D¹_{c} (where 0.90≦a≦1.8, 0≦b≦0.5, and 0≦c≦0.05); LiE_{2-b}B¹_{b}O_{4-c}D¹_{c} (where 0≦b≦0.5, and 0≦c≦0.05); LiₐNi_{1-b-c}Co_{b}B¹_{c}D¹_{α} (where 0.90≦a≦1.8, 0≦b≦0.5, 0≦c≦0.05, and 0<α≦2); LiₐNi_{1-b-c}Co_{b}B¹_{c}O_{2-α}F¹_{α} (where 0.90≦a≦1.8, 0≦b≦0.5, 0≦c≦0.05, and 0<α<2); LiₐNi_{1-b-c}Co_{b}B¹_{c}O_{2-α}F¹₂ (where 0.90≦a≦1.8, 0≦b≦0.5, 0≦c≦0.05, and 0<α<2); LiₐNi_{1-b-c}Mn_{b}B¹_{c}D¹_{α} (where 0.90≦a≦1.8, 0≦b≦0.5, 0≦c≦0.05, and 0<α≦2); LiₐNi_{1-b-c}Mn_{b}B¹_{c}O_{2-α}F¹_{α} (where 0.90≦a≦1.8, 0≦b≦0.5, 0≦c≦0.05, and 0<α<2); LiₐNi_{1-b-c}Mn_{b}B¹_{c}O_{2-α}F¹₂ (where 0.90≦a≦1.8, 0≦b≦0.5, 0≦c≦0.05, and 0<α<2); LiₐNi_{b}E_{c}G_{d}O₂ (where 0.90≦a≦1.8, 0≦b≦0.9, 0≦c≦0.5, and 0.001≦d≦0.1); LiₐNi_{b}Co_{c}Mn_{d}GeO₂ (where 0.90≦a≦1.8, 0≦b≦0.9, 0≦c≦0.5, 0≦d≦0.5, and 0.001≦e≦0.1); LiₐNiG_{b}O₂ (where 0.90≦a≦1.8, and 0.001≦b≦0.1); LiₐCoG_{b}O₂ (where 0.90≦a≦1.8, and 0.001≦b≦0.1); LiₐMnG_{b}O₂ (where 0.90≦a≦1.8, and 0.001≦b≦0.1); LiₐMn₂G_{b}O₄ (where 0.90≦a≦1.8, and 0.001≦b≦0.1); QO₂; QS₂; LiQS₂; V₂O₅; LiV₂O₅; LiI¹O₂; LiNiVO₄; Li_{(3-f)}J₂(PO₄)₃ (0≦f≦2); Li_{(3-f)}Fe₂(PO₄)₃ (0≦f≦2); and LiFePO₄.

In the formulae above, A may be selected from the group consisting of nickel (Ni), cobalt (Co), manganese (Mn), and combinations thereof; B¹ may be selected from the group consisting of aluminum (Al), nickel (Ni), cobalt (Co), manganese (Mn), chromium (Cr), iron (Fe), magnesium (Mg), strontium (Sr), vanadium (V), a rare earth element, and combinations thereof; D¹ may be selected from the group consisting of oxygen (O), fluorine (F), sulfur (S), phosphorus (P), and combinations thereof; E may be selected from the group consisting of cobalt (Co), manganese (Mn), and combinations thereof; F¹ may be selected from the group consisting of fluorine (F), sulfur (S), phosphorus (P), and combinations thereof; G may be selected from the group consisting of aluminum (Al), chromium (Cr), manganese (Mn), iron (Fe), magnesium (Mg), lanthanum (La), cerium (Ce), strontium (Sr), vanadium (V), and combinations thereof; Q is selected from the group consisting of titanium (Ti), molybdenum (Mo), manganese (Mn), and combinations thereof; I¹ may be selected from the group consisting of chromium (Cr), vanadium (V), iron (Fe), scandium (Sc), yttrium (Y), and combinations thereof; and J may be selected from the group consisting of vanadium (V), chromium (Cr), manganese (Mn), cobalt (Co), nickel (Ni), copper (Cu), and combinations thereof.

In some embodiments, the compounds listed above as positive active materials may have a surface coating layer (hereinafter, “coating layer”). In some embodiments, a mixture of a compound without having a coating layer and a compound having a coating layer, the compounds being selected from the compounds listed above, may be used. In some embodiments, the coating layer may include at least one compound of a coating element selected from the group consisting of oxide, hydroxide, oxyhydroxide, oxycarbonate, and hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or mixtures thereof. The coating layer may be formed using any method that does not adversely affect the physical properties of the cathode active material when a compound of the coating element is used. For example, the coating layer may be formed using a spray coating method, a dipping method, or the like.

In some embodiments, the cathode active material may be LiNiO₂, LiCoO₂, LiMnₓO₂ₓ (x=1, 2), LiNi₁₋ₓMnₓO₂ (0<x<1), LiNi_{1-x-y}CoₓMn_{y}O₂ (0≦x≦0.5, 0≦y≦0.5), LiFeO₂, V₂O₅, TiS, and MoS.

In some embodiments, the conducting agent, the binder and the solvent used for the cathode active material composition may be the same as those used for the anode active material composition. In some embodiments, a plasticizer may be further added into the cathode active material composition or the anode active material composition to form pores in the electrode plates. In some embodiments, a plasticizer may be further added into the cathode active material composition and the anode active material composition to form pores in the electrode plates.

The amounts of the cathode electrode active material, the conducting agent, the binder, and the solvent are those levels that are generally used to the manufacture of a lithium battery. At least one of the conducting agent, the binder and the solvent may not be used according to the use and the structure of the lithium battery.

Next, a separator to be disposed between the cathode and the anode is prepared. The separator may be any separator that is commonly used for lithium batteries. In some embodiments, the separator may have low resistance to migration of ions in an electrolyte and have an excellent electrolyte-retaining ability. Examples of the separator include, but are not limited to, glass fiber, polyester, polyethylene, polypropylene, polytetrafluoroethylene (PTFE), and a combination thereof, each of which may be a non-woven or woven fabric. For example, a rollable separator including polyethylene or polypropylene may be used for a lithium ion battery. In some embodiments, a separator with a good organic electrolyte solution-retaining ability may be used for a lithium ion polymer battery. For example, the separator may be manufactured in the following manner.

In some embodiments, a polymer resin, a filler, and a solvent may be mixed together to prepare a separator composition. In some embodiments, the separator composition may be directly coated on an electrode, and then dried to form the separator. In some embodiments, the separator composition may be cast on a support and then dried to form a separator film, which may then be separated from the support and laminated on an electrode to form the separator.

In some embodiments, the polymer resin used to manufacture the separator may be any material that is commonly used as a binder for electrode plates. Examples of the polymer resin are a vinylidenefluoride/hexafluoropropylene copolymer, polyvinylidene fluoride (PVDF), polyacrylonitrile, polymethylmethacrylate and a mixture thereof.

Next, an electrolyte is prepared.

In some embodiments, the electrolyte may be an organic electrolyte solution. In some embodiments, the electrolyte may be in a solid phase. Non-limiting examples of the electrolyte are lithium oxide and lithium oxynitride. Any material available as a solid electrolyte in the art may be used. In some embodiments, the solid electrolyte may be formed on the anode by, for example, sputtering.

In some embodiments, an organic electrolyte solution may be prepared by dissolving a lithium salt in an organic solvent.

The organic solvent may be any solvent available as an organic solvent in the art. In some embodiments, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, and mixtures thereof.

In some embodiments, the lithium salt may be any material available as a lithium salt in the art. Examples of the lithium salt are LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each independently a natural number of 1 to 20, respectively), LiCl, LiI and a mixture thereof.

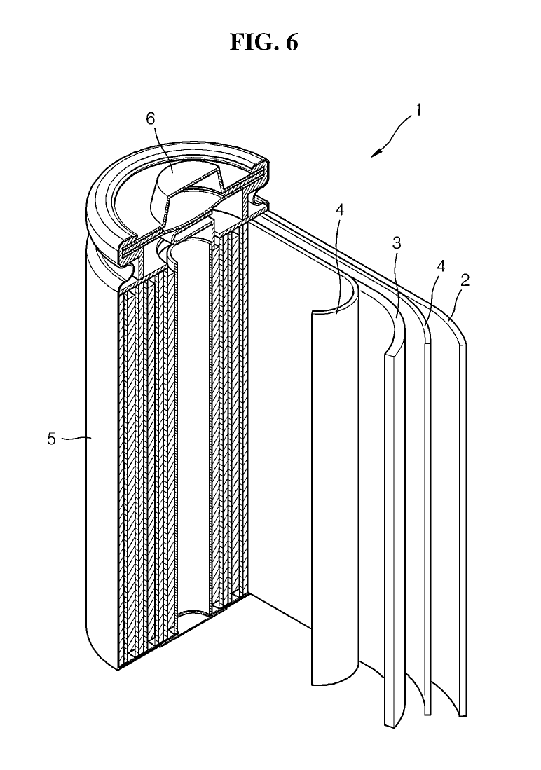

Referring to FIG. 6, a lithium battery 1 includes a cathode 3, an anode 2, and a separator 4. In some embodiments, the cathode 3, the anode 2 and the separator 4 may be wound or folded, and then sealed in a battery case 5. In some embodiments, the battery case 5 may be filled with an organic electrolyte solution and sealed with a cap assembly 6, thereby completing the manufacture of the lithium battery 1. In some embodiments, the battery case 5 may be a cylindrical type, a rectangular type, or a thin-film type. For example, the lithium battery may be a thin-film type battery. In some embodiments, the lithium battery may be a lithium ion battery.

In some embodiments, the separator may be interposed between the cathode and the anode to form a battery assembly. In some embodiments, the battery assembly may be stacked in a bi-cell structure and impregnated with the electrolyte solution. In some embodiments, the resultant component may be put into a pouch and hermetically sealed, thereby completing the manufacture of a lithium ion polymer battery.

In some embodiments, a plurality of battery assemblies may be stacked to form a battery pack, which may be used in any device that operates at high temperatures and requires high output, for example, in a laptop computer, a smart phone, electric vehicle, and the like.

In some embodiments, the lithium battery may have improved high rate characteristics and lifetime characteristics, and thus may be applicable in an electric vehicle (EV), for example, in a hybrid vehicle such as plug-in hybrid electric vehicle (PHEV).

Some embodiments provide a method of preparing a composite anode active material includes: mixing a metal alkoxide, a composite and a solvent together to prepare a mixed solution; drying the mixed solution to obtain a dried product; and calcining the dried product, wherein the composite includes a carbonaceous substrate and a nanostructure disposed on the carbonaceous substrate. In some embodiments, the nanostructure may be a metal/metalloid nanostructure.

In some embodiments, the metal alkoxide may be a form of sol and may be an organic metal compound with alkoxide group coordinated to metal ions. The metal alkoxide may be prepared by refluxing a mixture of, for example, about 1 to 10 parts by weight of a metal salt with 100 parts by alcohol, but may be any method known in the art, not limited to the method.

In some embodiments of the preparation method, a weight ratio of the metal alkoxide to the composite used to obtain the mixed solution may be from about 0.1:100 to about 20:100, and in some other embodiments, form about 1:100 to about 10:100. When the amount of the metal alkoxide is too low, a coating effect of such a small amount of the metal alkoxide may be negligible. When the amount of the metal alkoxide is too high, this may lead to reduced specific capacity.

In some embodiments of the preparation method, a metal of the metal alkoxide may be at least one selected from the group consisting of Zr, Ni, Co, Mn, B, Mg, Ca, Sr, Ba, V, Fe, Cu, and Al.

In some embodiments, the metal alkoxide may be represented by Formula 2 below:

M(OR)ₓ Formula 2

In Formula 2, 1≦x≦5; each R may independently be C 1-C10 linear or branched alkyl group; and M may be selected from the group consisting of Zr, Ni, Co, Mn, B, Mg, Ca, Sr, Ba, Ti, V, Fe, Cu, and Al.

In some embodiments of the preparation method, the solvent may be at least one selected from the group consisting of water, methanol, ethanol, isopropyl alcohol, and a mixture thereof, but is not limited thereto. Any solvent available in the art that may achieve the purpose of the preparation method may be used.

In some embodiments of the preparation method, the calcining of the dried product may be performed in a nitrogen or air atmosphere at a temperature of from about 400° C. to about 900° C. for from about 2 hours to about 15 hours. When the heating temperature is too low, unreacted residues may remain as impurities. When the heating temperature is too high, a reaction of carbon in graphite with oxygen in the metal oxide may occur.

In some embodiments, the preparation method may further include grinding a heated product from the heating operation.

In some embodiments, the composite anode active material may be prepared using a dry method, not the above-described wet method, including mechanically mixing metal oxide particles and a composite core together to form a coating layer including the metal oxide particles on the composite core. In some embodiments, the mixing may be performed using, for example, mechanofusion method. In some embodiments, the dry method may further include heating the coating layer after the forming of the coating layer on the composite core.

Hereinafter, one or more embodiments of the present disclosure will be described in detail with reference to the following examples. However, these examples are not intended to limit the scope of the one or more embodiments of the present disclosure.

### Preparation of Composite Core

### PREPARATION EXAMPLE 1

Si nanowires (SiNW) were grown on spherical graphite using a vapor-liquid-solid (VLS) growing method. The spherical graphite used was spherical natural graphite (available from Hitachi Chemical Co., Tokyo, Japan) having an average diameter of about 10 μm. After forming an Ag catalyst on a surface of the spherical graphite, SiH₄ gas was flowed at a temperature of about 500° C. or greater to grow Si nanowires thereon, thereby preparing a composite core.

Particles of the spherical graphite were randomly sampled, and analyzed using FPIA-3000 (Malvern Instruments Ltd., Malvern, United Kingdom) to measure circularities. As a result, the spherical graphite particles had a circularity ranging from about 0.808 to about 1.000 as follows. The measured circularities of the spherical graphite were as follows:
Circularity; 0.808, 0.844, 0.861, 0.878, 0.879, 0.883, 0.884, 0.888, 0.891, 0.892, 0.907, 0.908, 0.913, 0.914, 0.916, 0.918, 0.922, 0.923, 0.924, 0.928, 0.929, 0.934, 0.935, 0.937, 0.938, 0.939, 0.942, 0.943, 0.946, 0.946, 0.947, 0.948, 0.949, 0.952, 0.956, 0.959, 0.961, 0.962, 0.963, 0.963, 0.963, 0.964, 0.964, 0.966, 0.967, 0.967, 0.970, 0.972, 0.976, 0.977, 0.977, 0.977, 0.979, 0.979, 0.982, 0.983, 0.984, 0.986, 0.990, 0.994, 0.995, 0.996, 1.000, 1.000

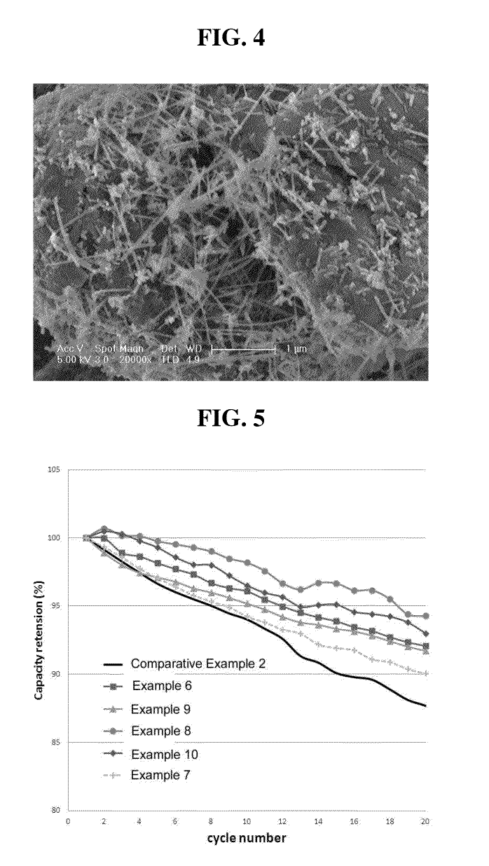

A field emission scanning electron microscopic (FE-SEM) image of the composite core is shown in FIG. 4.

The spherical graphite in the composite core are porous particles having a porosity of about 15 volume % based on a total volume of the spherical graphite. The grown Si nanowire had an average diameter of about 30 nm to about 50 nm, and an average length of about 1.5 μm. An amount of the Si nanowire in the composite core was about 8.0 wt % based on the total weight of the composite core.

### Preparation of Composite Anode Active Material

### EXAMPLE 1

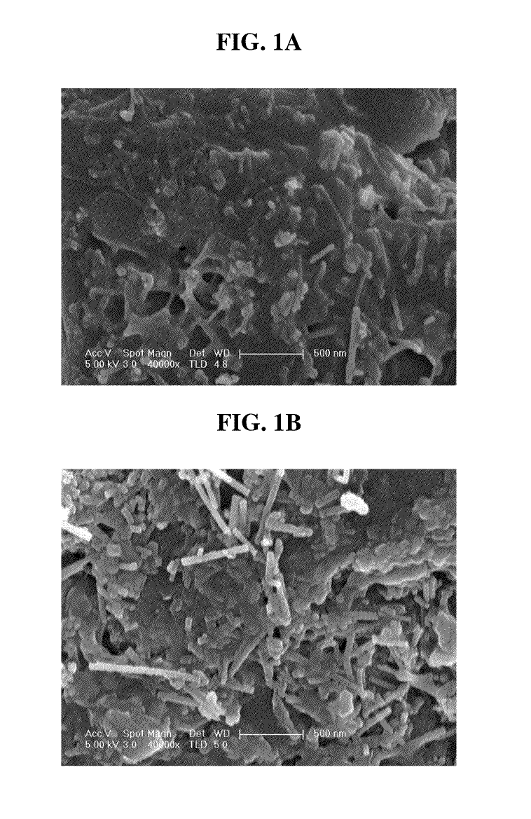

The composite core powder (25 g) prepared in Preparation Example 1 and 2.1 g of titanium isopropoxide [(Ti(OCH(CH₃)₂)₄, Product No. 205273, available from Aldrich, St. Louis, Mo.) were added to isopropylalcohol (200 mL) and mixed together to afford a mixture. The solvent was removed from the agitated mixture stirring at about 300 rpm by heating to about 100° C. to afford a dried powder. The dried powder was heated at about 600° C. for 1 hour under a nitrogen atmosphere to obtain a heated product. The heated product was ground to afford a composite anode active material with a composite core coated with titanium dioxide. FIGS. 1A and 1B are scanning electron microscopic (SEM) images of the composite anode active material of Example 1 before and after the heating, respectively.

### EXAMPLE 2

ZrO(NO₃) (2.346 g) and citric acid (4.26 g) were mixed with water (60 mL) to obtain a first mixture, and ethylene glycol (0.636 g) and the composite core powder (25 g) prepared in Preparation Example 1 were added to the first mixture to obtain a second mixture. The solvent was removed from the agitated second mixture stirring at about 300 rpm by heating to afford a dried powder. The dried powder was heated at about 600° C. for 1 hour under a nitrogen atmosphere to obtain a heated product.

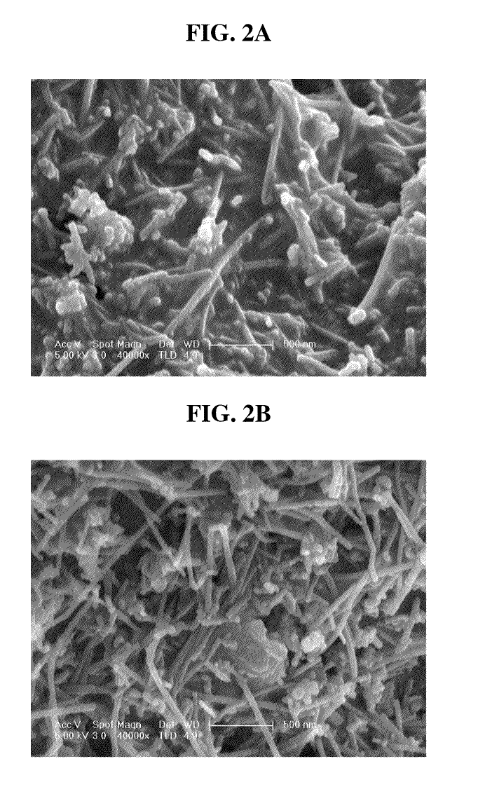

FIGS. 2A and 2B are SEM images of the composite anode active material of Example 2 before and after the heating, respectively.

### EXAMPLE 3

A composite anode active material was prepared in the same manner as in Example 1, except that 2.55 g of aluminum isopropoxide [(Al[OCH(CH₃)₂]₃), Product No. 220418, available from Aldrich), instead of 2.1 g of titanium isopropoxide, was used.

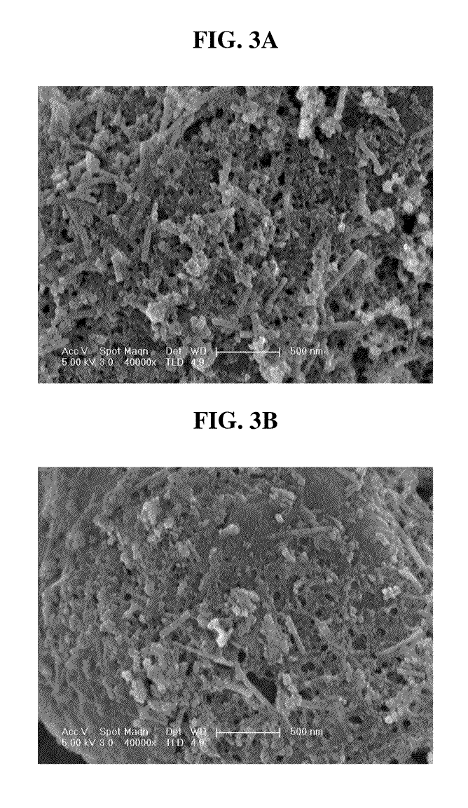

FIGS. 3A and 3B are SEM images of the composite anode active material of Example 3 before and after the heating, respectively.

### EXAMPLE 4

A composite anode active material was prepared in the same manner as in Example 1, except that 0.42 g of titanium isopropoxide was used.

### EXAMPLE 5

A composite anode active material was prepared in the same manner as in Example 1, except that 0.51 g of aluminum isopropoxide was used.

### COMPARATIVE EXAMPLE 1

The composite core prepared in Preparation Example 1 was used as the anode active material.

FIG. 4 is a SEM image of the composite core of Comparative Example 1.

### Manufacture of Anode, Cathode, and Lithium Battery

### EXAMPLE 6

A first mixture including the composite anode active material of Example 1 and graphite powder in a weight ratio of 25:75, and a second mixture including a binder of styrene butadiene rubber (SBR) and carboxymethyl cellulose (CMC) in a weight ratio of about 1:1 were mixed in a weight ratio of about 98:2 to prepare an anode active material slurry.

The anode active material slurry was coated in an amount of about 9 mg/cm² on a copper foil current collector having a thickness of about 10 μm. Subsequently, the anode active material slurry was dried at about 120° C. for about 15 minutes, and then pressed to prepare an anode plate.

In order to manufacture a cathode, LCO (LiCoO₂) as a cathode active material, carbon black as a conducting agent, and polyvinylidene fluoride (PVdF) as a binder were mixed in a weight ratio of about 97.5:1:1.5 to prepare a cathode active material slurry.

This cathode active material slurry was coated in an amount of about 18 mg/cm² on an aluminum foil current collector having a thickness of about 12 μm, then dried at about 120° C. for about 15 minutes and pressed to prepare a cathode plate.

A coin cell was manufactured using the cathode, the anode, a polyethylene separator (STAR 20, available from Asahi Kaisei Corporation, Tokyo, Japan), and an electrolyte solution including 1.15M LiPF₆ dissolved in a mixed solvent of ethylenecarbonate (EC), ethylmethylcarbonate (EMC) and diethylcarbonate (DEC) in a volume ratio of 3:3:4.

### EXAMPLES 7 TO 10

Lithium batteries were manufactured in the same manner as in Example 6, except that the composite anode active materials prepared in Examples 2 to 5 were respectively used.

### COMPARATIVE EXAMPLE 2

A lithium battery was manufactured in the same manner as in Example 6, except that the anode active material of Comparative Example 1 was used.

### EVALUATION EXAMPLE 1

### Evaluation of Thermal Decomposition Characteristics

The coin cells of Examples 7-12 and Comparative Example 2 were each charged with a constant current of 0.2 C rate at about 25° C. until the voltage of the cell reached about 4.3V (vs. Li), and then charged with a constant voltage of about 4.3V until the current reached 0.05 C rate. Afterward, the cell was discharged at a constant current of 0.5 C rate until the voltage reached 2.75V (vs. Li).

Subsequently, each of the cells was charged with a constant current of 0.5 C rate until the voltage of the cell reached about 4.3V, and then charged with a constant voltage of about 4.3V until the current reached 0.05 C rate, followed by discharging with a constant current of 0.5 C rate until the voltage reached about 2.75V (with respect to Li) (formation process).

Subsequently, each of the lithium batteries after the formation process was charged with a constant current of 1.5 C rate at about 25° C. until the voltage of the cell reached about 4.3V, and then charged with a constant voltage of about 4.3V until the current reached 0.05 C, followed by discharging with a constant current of about 1.0 C rate until the voltage reached about 2.75V. This cycle of charging and discharging was repeated 20 times.

The high-rate charge/discharge test results are shown in Table 1 and FIG. 5. The capacity retention rate was represented by Equation 1 below.

Capacity retention rate (%)=[20^{th} cycle discharge capacity/1^{st} cycle discharge capacity]×100 Equation 1

TABLE 1

| | Capacity retention rate | Discharge capacity at 20^{th} |
|---|---|---|
| | at 20^{th} cycle [%] | cycle (mAh/g) |
| Example 6 | 92.3 | 504 |
| Example 7 | 90.4 | 509 |
| Example 8 | 94.4 | 502 |
| Example 9 | 92.0 | 453 |
| Example 10 | 93.8 | 522 |
| Comparative | 88.1 | 507 |
| Example 2 | | |

Referring to Table 1, the lithium batteries of Examples 6 to 10 are found to have improved lifetime characteristics as compared with that of Comparative Example 2. The lithium batteries of Examples 1 to 5 were found to have improved discharge capacities relative to a theoretical discharge capacity of about 372 mAh/g for graphite.

As described above, according to the exemplary embodiments, a lithium battery may have improved discharge capacity and lifetime characteristics by using a composite anode active material including a metal oxide disposed on a composite core.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A composite anode active material comprising:
a composite core; and
a coating layer covering at least a region of the composite core, wherein the composite core comprises a carbonaceous substrate; and a metal/metalloid nanostructure disposed on the substrate, and the coating layer comprises a metal oxide.

2. The composite anode active material of claim 1, wherein the metal in the metal oxide is at least one selected from among the elements of Groups 2 to 13 of the periodic table of elements.

3. The composite anode active material of claim 1, wherein the metal of the metal oxide is at least one selected from the group consisting of zirconium (Zr), nickel (Ni), cobalt (Co), manganese (Mn), boron (B), magnesium (Mg), calcium (Ca), strontium (Sr), barium (Ba), titanium (Ti), vanadium (V), iron (Fe), copper (Cu), and aluminum (Al).

4. The composite anode active material of claim 1, wherein the metal oxide is represented by Formula 1 below:
MₐO_{b} Formula 1
wherein, in Formula 1, 1≦a≦4, 1≦b≦10, and M is at least one selected from the group consisting of zirconium (Zr), nickel (Ni), cobalt (Co), manganese (Mn), boron (B), magnesium (Mg), calcium (Ca), strontium (Sr), barium (Ba), titanium (Ti), vanadium (V), iron (Fe), copper (Cu), and aluminum (Al).

5. The composite anode active material of claim 1, wherein the metal oxide comprises at least one selected from the group consisting of titanium oxide, aluminum oxide, chromium trioxide, zinc oxide, copper oxide, magnesium oxide, zirconium dioxide, molybdenum trioxide, vanadium pentoxide, niobium pentoxide, and tantalum pentoxide.

6. The composite anode active material of claim 1, wherein the metal oxide is inert with respect to lithium.

7. The composite anode active material of claim 1, wherein the metal oxide does not form a lithium metal oxide with lithium.

8. The composite anode active material of claim 1, wherein the nanostructure has at least one form selected from the group consisting of nanowire, nanotube, nanobelt, nanorod, nanoporous body, and nanotemplate.

9. The composite anode active material of claim 1, wherein the metal/metalloid nanostructure comprises at least one element selected from the group consisting of the elements of Groups 13, 14, and 15 of the periodic table of elements.

10. The composite anode active material of claim 1, wherein the metal/metalloid nanostructure comprises at least one element selected from the group consisting of Si, Ge and Sn.

11. The composite anode active material of claim 1, wherein the metal/metalloid nanostructure is a silicon nanowire.

12. The composite anode active material of claim 1, wherein the carbonaceous substrate has a spherical or planar form.

13. The composite anode active material of claim 1, wherein the carbonaceous substrate comprises at least one selected from the group consisting of natural graphite, artificial graphite, expanded graphite, graphene, carbon black, and fullerene soot.

14. An anode comprising the composite anode active material of claim 1; and a current collector.

15. A lithium battery comprising the anode of claim 14; and a cathode.

16. A method of preparing a composite anode active material, the method comprising:
mixing a metal alkoxide, a composite, and a solvent together to prepare a mixed solution;
drying the mixed solution to obtain a dried product; and
heating the dried product,
wherein the composite comprises a carbonaceous substrate; and a metal/metalloid nanostructure disposed on the carbonaceous substrate.

17. The method of claim 16, wherein a weight ratio of the metal alkoxide to the composite in the mixed solution is from about 0.1:100 to about 20:100.

18. The method of claim 16, wherein the metal in the metal alkoxide is at least one selected from the group consisting of Zr, Ni, Co, Mn, B, Mg, Ca, Sr, Ba, V, Fe, Cu, and Al.

19. The method of claim 16, wherein the solvent includes at least one selected from the group consisting of water, methanol, ethanol, and isopropyl alcohol.

20. The method of claim 16, wherein the heating is performed under a nitrogen or air atmosphere at a temperature of from about 400° C. to about 900° C. for from about 8 hours to about 15 hours.
